(19) United States
(12) Patent Application Publication
(10) Pub. No.: US 2016/0366650 A1
(43) Pub. Date: Dec. 15, 2016

(54) WIRELESS COMMUNICATION DEVICE AND WIRELESS COMMUNICATION METHOD

(71) Applicant: FUJITSU LIMITED, Kawasaki-shi (JP)

(72) Inventors: Hiroki SATOU, Sendai (JP); Mitsuo KOBAYASHI, Natori (JP); Toshifumi FUJIMOTO, Kawasaki (JP); Katsutoshi USAMI, Kawasaki (JP)

(21) Appl. No.: 15/171,665

(22) Filed: Jun. 2, 2016

(30) Foreign Application Priority Data
Jun. 12, 2015 (JP) 2015-118992

(51) Int. Cl. H04W 52/04; H04W 52/02; H04W 72/04

(52) U.S. Cl. CPC H04W 52/04; H04W 72/0406; H04W 52/0209; H04W 88/02

(57) ABSTRACT

A wireless communication device including: a memory, and a processor coupled to the memory and configured to: receive a first control signal and a second control signal from another wireless communication device, the first control signal being a control signal for adjusting a transmission timing of the wireless communication device, the second control signal being a control signal for adjusting a transmission power of the wireless communication device, perform a first adjustment for the transmission power of the wireless communication device based on the second control signal, start a second adjustment for the transmission power of the wireless communication device based on the first control signal, and stop the second adjustment based on a received power from the another wireless communication device.

### CROSS-REFERENCE TO RELATED APPLICATION

This application is based upon and claims the benefit of priority of the prior Japanese Patent Application No. 2015-118992, filed on Jun. 12, 2015, the entire contents of which are incorporated herein by reference.

### FIELD

The embodiment discussed herein is related to a wireless communication device and a wireless communication method.

### BACKGROUND

In the past, a technique of performing control by which a mobile station monitors the amount of change in timing with which the mobile station transmits data to a base station and, when the amount of change in timing with which the mobile station transmits data to the base station reaches a predetermined value, the mobile station decreases, a predetermined number of times, the value of transmit power which is used for transmission of data to the base station has been known (see, for example, Japanese Laid-open Patent Publication No. 2013-030840). Moreover, a technique of allowing a mobile communication terminal to increase or decrease transmit power based on the judgment result of a received power value has been known (see, for example, Japanese Laid-open Patent Publication No. 2004-88333).

### SUMMARY

According to an aspect of the invention, a wireless communication device includes a memory, and a processor coupled to the memory and configured to: receive a first control signal and a second control signal from another wireless communication device, the first control signal being a control signal for adjusting a transmission timing of the wireless communication device, the second control signal being a control signal for adjusting a transmission power of the wireless communication device, perform a first adjustment for the transmission power of the wireless communication device based on the second control signal, start a second adjustment for the transmission power of the wireless communication device based on the first control signal, and stop the second adjustment based on a received power from the another wireless communication device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram depicting an example of a communication system according to an embodiment;

FIG. 2 is a diagram depicting an example of the flow of power control in the communication system according to the embodiment;

FIG. 3 is a diagram depicting an example of a terminal according to the embodiment;

FIG. 4 is a diagram depicting an example of a transmit power setting portion of the terminal according to the embodiment;

FIG. 5 is a diagram depicting an example of the hardware configuration of the terminal according to the embodiment;

FIG. 6 is a diagram depicting an example of the hardware configuration of a base station according to the embodiment;

FIG. 7 is a flowchart of an example of transmit power setting processing which is performed by the terminal according to the embodiment;

FIG. 8 is a diagram depicting an example of transmit power control which is performed by the terminal according to the embodiment; and

FIG. 9 is a flowchart of another example of the transmit power setting processing which is performed by the terminal according to the embodiment.

### DESCRIPTION OF EMBODIMENT

However, in the above-described existing techniques, if, for example, control by which the value of transmit power is decreased a predetermined number of times based on the amount of change in timing with which data is transmitted to the base station is performed, depending on the state of movement of a terminal or a propagation environment, the transmit power is undesirably decreased excessively.

Alternatively, performing control by which the value of transmit power is increased a predetermine number of times based on the amount of change in timing with which data is transmitted to the base station is conceivable, but performing such control may result in an excessive increase in transmit power depending on the state of movement of a terminal or a propagation environment.

The embodiment provides a transmitting device that is capable of curbing an excessive decrease or increase in transmit power.

Hereinafter, with reference to the drawings, an embodiment of a transmitting device will be described.

### Embodiment

### A Communication System According to the Embodiment

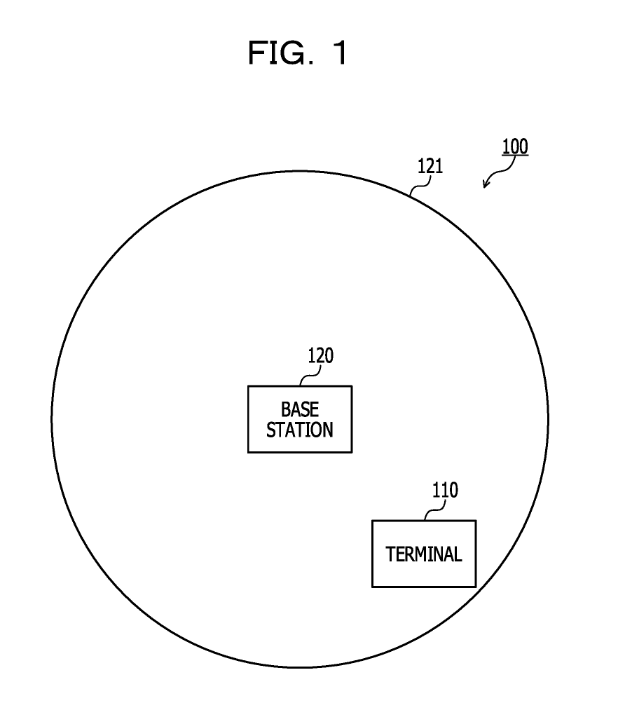

FIG. 1 is a diagram depicting an example of a communication system according to the embodiment. As depicted in FIG. 1, a communication system 100 according to the embodiment includes a terminal 110 and a base station 120. The base station 120 forms a cell 121 and performs radio communication with the terminal 110 which is present in the cell 121. The terminal 110 is a transmitting device that transmits a radio signal to the base station 120. Moreover, the terminal 110 receives a radio signal from the base station 120.

The base station 120 transmits, to the terminal 110, a first control signal indicating the amount of control of transmission timing with which transmission to the base station 120 from the terminal 110 is performed. For example, the base station 120 transmits, to the terminal 110, the first control signal based on reception timing with which the radio signal from the terminal 110 is received by the base station 120. The first control signal is, for example, timing advance (TA) information.

Moreover, the base station 120 transmits, to the terminal 110, a second control signal indicating the amount of control of transmit power to the base station 120 from the terminal 110. For example, the base station 120 transmits, to the terminal 110, the second control signal based on the received power of the radio signal from the terminal 110 in the base station 120. The second control signal is, for example, a transmit power control (TPC) value.

(The Flow of Power Control in the Communication System According to the Embodiment)

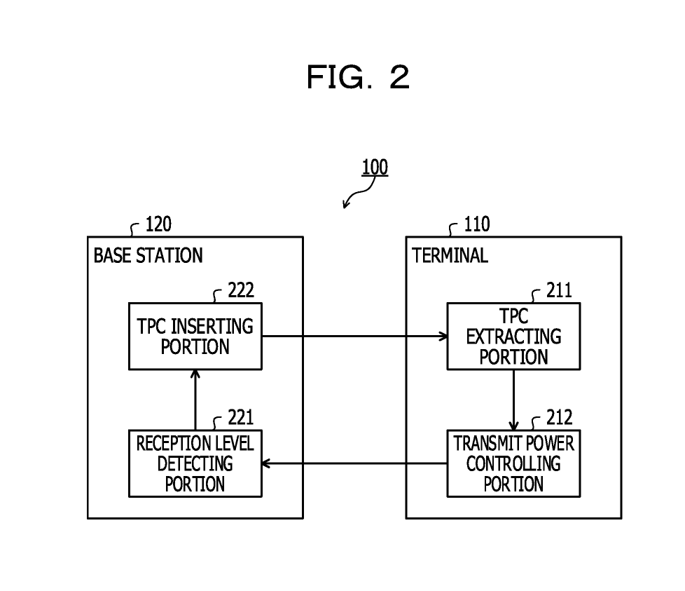

FIG. 2 is a diagram depicting an example of the flow of power control in the communication system according to the embodiment. As depicted in FIG. 2, the base station 120 includes a reception level detecting portion 221 and a TPC inserting portion 222. The reception level detecting portion 221 detects the reception level of the radio signal from the terminal 110 in the base station 120. Then, the reception level detecting portion 221 notifies the TPC inserting portion 222 of the detected reception level.

If the reception level notified by the reception level detecting portion 221 is higher than a predetermined range, the TPC inserting portion 222 inserts a TPC value (a down command) which gives a command to lower the transmission level into a downlink control channel in a radio signal which the base station 120 transmits to the terminal 110. Moreover, if the reception level notified by the reception level detecting portion 221 is lower than the predetermined range, the TPC inserting portion 222 inserts a TPC value (an up command) which gives a command to raise the transmission level into a downlink control channel in a radio signal which the base station 120 transmits to the terminal 110. The insertion of the TPC value is performed in each frame (at intervals of 1 ms, for example).

The terminal 110 includes a TPC extracting portion 211 and a transmit power controlling portion 212. The TPC extracting portion 211 extracts the TPC value from the downlink control channel in the radio signal transmitted from the base station 120. Then, the TPC extracting portion 211 notifies the transmit power controlling portion 212 of the extracted TPC value.

The transmit power controlling portion 212 controls (or adjusts) the transmit power of the radio signal to the base station 120 from the terminal 110 based on the TPC value notified by the TPC extracting portion 211. For example, if the TPC value is a down command which gives a command to lower the transmission level, the transmit power controlling portion 212 lowers the transmit power of the radio signal to the base station 120 from the terminal 110. Moreover, if the TPC value is an up command which gives a command to raise the transmission level, the transmit power controlling portion 212 raises the transmit power of the radio signal to the base station 120 from the terminal 110. The control of the transmit power performed by the transmit power controlling portion 212 is performed in each frame, for example.

As a result, it is possible to control the transmit power to the base station 120 from the terminal 110 such that the received power in the base station 120 falls within the predetermined range.

(The Terminal According to the Embodiment)

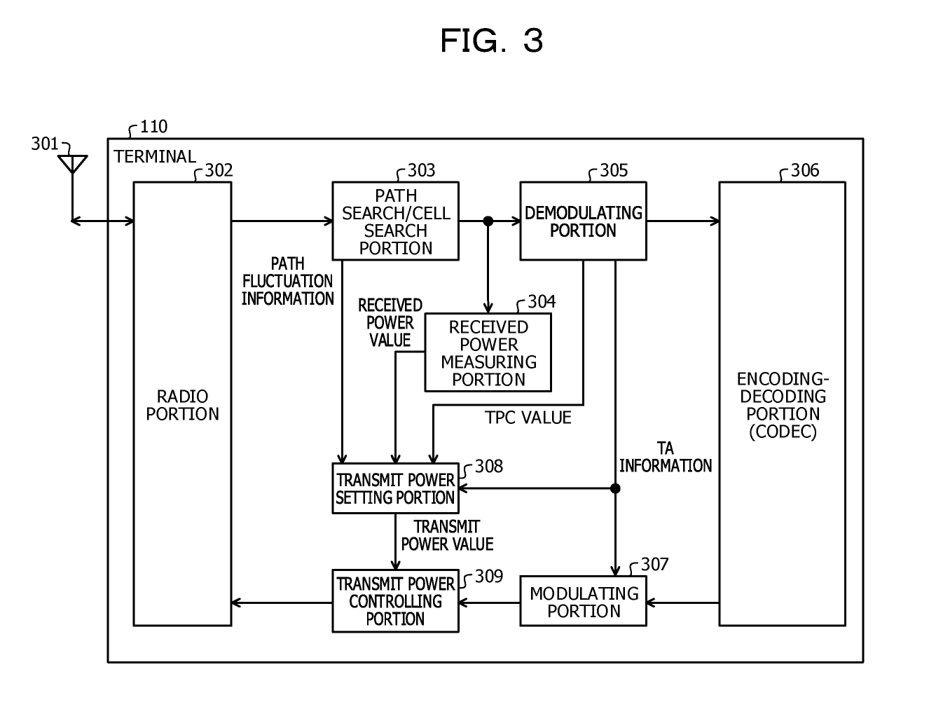

FIG. 3 is a diagram depicting an example of the terminal according to the embodiment. As depicted in FIG. 3, the terminal 110 according to the embodiment includes, for example, an antenna 301, a radio portion 302, a path search/cell search portion 303, a received power measuring portion 304, a demodulating portion 305, and an encoding-decoding portion 306 (CODEC). Moreover, the terminal 110 includes a modulating portion 307, a transmit power setting portion 308, and a transmit power controlling portion 309.

The TPC extracting portion 211 of the terminal 110 depicted in FIG. 2 may be implemented by the antenna 301, the radio portion 302, the path search/cell search portion 303, and the demodulating portion 305, for example. The transmit power controlling portion 212 of the terminal 110 depicted in FIG. 2 may be implemented by the transmit power setting portion 308 and the transmit power controlling portion 309, for example.

The antenna 301 is an antenna for transmitting and receiving signals between the terminal 110 and the base station 120 by radio. The radio portion 302 receives a signal from the base station 120 via the antenna 301 by radio and performs received signal processing on the received signal. The received signal processing which is performed by the radio portion 302 includes, for example, amplification, frequency conversion from a radio frequency (RF) band to a baseband, and an analog/digital converter (ADC). The radio portion 302 outputs the signal on which the radio portion 302 has performed the received signal processing to the path search/cell search portion 303.

Moreover, the radio portion 302 performs transmit signal processing on the signal output from the transmit power controlling portion 309. The transmit signal processing which is performed by the radio portion 302 includes, for example, a digital/analog converter (DAC), frequency conversion from a baseband to an RF band, and amplification. The radio portion 302 transmits the signal on which the radio portion 302 has performed the transmit signal processing to the base station 120 via the antenna 301 by radio.

The path search/cell search portion 303 performs path search (downlink following control) and cell search based on the signal output from the radio portion 302. The path search is, for example, processing which judges the timing of a path with a large correlation value by measuring a correlation value with each timing while gradually changing the timing of a spread code by which the signal output from the radio portion 302 is multiplied. The cell search is, for example, processing which selects a cell (a sector) in which the propagation loss between the terminal 110 and the base station 120 is minimized. The path search/cell search portion 303 outputs the signal on which the path search/cell search portion 303 has performed the path search and the cell search to the received power measuring portion 304 and the demodulating portion 305.

Moreover, the path search/cell search portion 303 may output, to the transmit power setting portion 308, path fluctuation information indicating downlink path fluctuations to the terminal 110 from the base station 120, the downlink path fluctuations measured by the path search. The downlink path fluctuations are fluctuations in path timing (for example, reception timing) of the signal which the terminal 110 receives from the base station 120. If the terminal 110 moves in a direction in which the terminal 110 moves closer to the base station 120, the downlink path fluctuations take a minus value; if the terminal 110 moves in a direction in which the terminal 110 moves away from the base station 120, the downlink path fluctuations take a plus value.

The received power measuring portion 304 measures the received power of the radio signal from the base station 120 in the terminal 110 based on the signal output from the path search/cell search portion 303. The received power measured by the received power measuring portion 304 may be, for example, received power in the terminal 110 from a serving cell which performs link control between the terminal 110 and the base station 120. The received power may be, for example, reference signal received power (RSRP). The received power measuring portion 304 outputs a received power value indicating the measured received power to the transmit power setting portion 308.

The demodulating portion 305 demodulates the signal output from the path search/cell search portion 303. Then, the demodulating portion 305 outputs the demodulated signal to the encoding-decoding portion 306. Moreover, the demodulating portion 305 outputs the TPC value included in the demodulated signal to the transmit power setting portion 308. Furthermore, the demodulating portion 305 outputs the TA information included in the demodulated signal to the modulating portion 307 and the transmit power setting portion 308.

The encoding-decoding portion 306 decodes the signal output from the demodulating portion 305. As a result, the data transmitted to the terminal 110 from the base station 120 is obtained. Moreover, the encoding-decoding portion 306 encodes data to be transmitted to the base station 120 from the terminal 110. Then, the encoding-decoding portion 306 outputs the signal obtained by encoding to the modulating portion 307.

The modulating portion 307 performs modulation based on the signal output from the encoding-decoding portion 306. Then, the modulating portion 307 outputs the signal obtained by modulation to the transmit power controlling portion 309. Moreover, the modulating portion 307 adjusts the timing with which the terminal 110 transmits the signal to the base station 120 by adjusting the timing with which the modulating portion 307 outputs the signal to the transmit power controlling portion 309 based on the TA information output from the demodulating portion 305.

The TA information which gives a command to adjust the transmission timing takes a minus value if the terminal 110 moves in a direction in which the terminal 110 moves closer to the base station 120 and takes a plus value if the terminal 110 moves in a direction in which the terminal 110 moves away from the base station 120. Moreover, the higher the movement speed of the terminal 110, the more frequently the TA information is transmitted to the terminal 110 from the base station 120.

Moreover, the modulating portion 307 may acquire the path fluctuation information which is output from the path search/cell search portion 303. Then, the modulating portion 307 may make a fine adjustment to the timing with which the terminal 110 transmits the signal to the base station 120 by making a fine adjustment to the timing with which the modulating portion 307 outputs the signal to the transmit power controlling portion 309 based on the acquired path fluctuation information. For example, the modulating portion 307 roughly adjusts the signal transmission timing based on the TA information and makes a fine adjustment to the signal transmission timing based on the path fluctuation information.

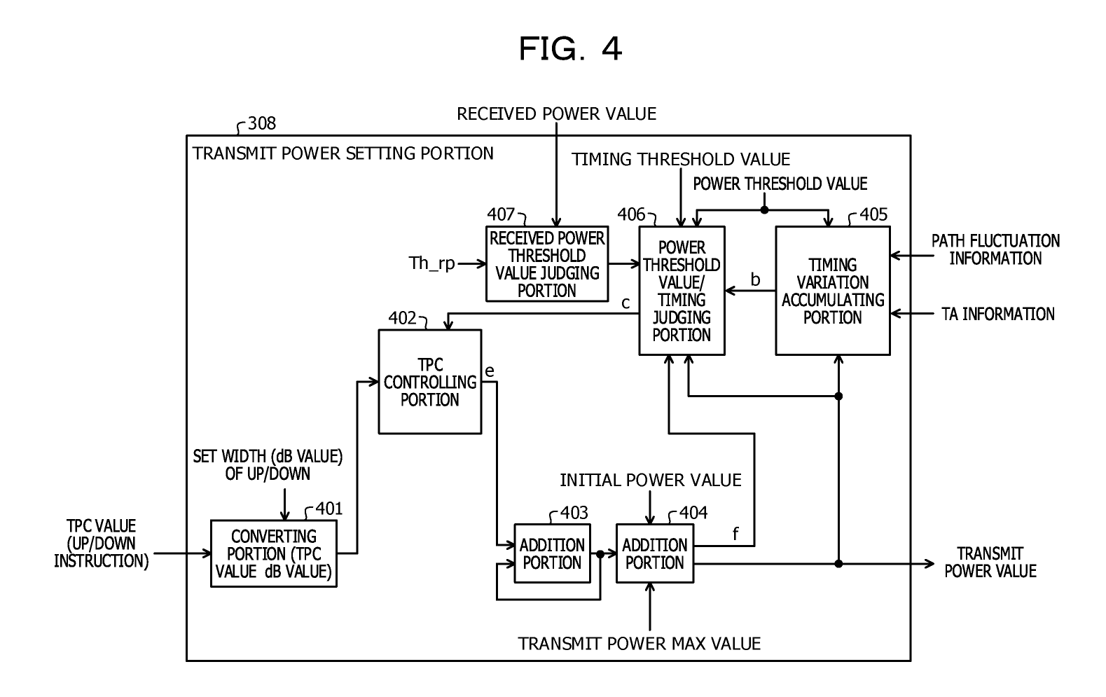

The transmit power setting portion 308 sets a transmit power value of the signal to the base station 120 from the terminal 110 and outputs the set transmit power value to the transmit power controlling portion 309. The transmit power setting portion 308 makes the setting of the transmit power based on, for example, the received power value output from the received power measuring portion 304 and the TPC value and the TA information output from the demodulating portion 305. Moreover, the transmit power setting portion 308 may use the path fluctuation information output from the path search/cell search portion 303 for the setting of the transmit power. The setting of the transmit power which is made by the transmit power setting portion 308 will be described later (see, for example, FIG. 4).

The transmit power controlling portion 309 controls the transmit power of the signal output from the modulating portion 307 based on the transmit power value output from the transmit power setting portion 308. Then, the transmit power controlling portion 309 outputs the signal whose transmit power has been controlled to the radio portion 302.

A receiving portion which receives the TA information (the first control signal) and the TPC value (the second control signal) may be implemented by the antenna 301, the radio portion 302, the path search/cell search portion 303, and the demodulating portion 305, for example. A storing portion (an accumulating portion that accumulates the amount of control) which stores the addition result of the amount of control indicated by the TA information (the first control signal) may be implemented by the transmit power setting portion 308, for example. A controlling portion which controls the transmit power of the terminal 110 based on the TPC value (the second control signal) may be implemented by the transmit power setting portion 308 and the transmit power controlling portion 309, for example.

(The Transmit Power Setting Portion of the Terminal According to the Embodiment)

FIG. 4 is a diagram depicting an example of the transmit power setting portion of the terminal according to the embodiment. The transmit power setting portion 308 of the terminal 110 depicted in FIG. 3 includes, as depicted in FIG. 4, a converting portion 401, a TPC controlling portion 402, addition portions 403 and 404, a timing variation accumulating portion 405, a received power threshold value judging portion 407, and a power threshold value/timing judging portion 406.

To the converting portion 401, the TPC value (the up command or the down command) output from the demodulating portion 305 (see FIG. 3) is input. Moreover, in the converting portion 401, a set width (a dB value) of up or down of the transmit power in accordance with the command of the TPC value is set. This set width is an arbitrary fixed value, for example. The converting portion 401 converts the input TPC value into a dB value based on the set width thus set. Then, the converting portion 401 outputs the TPC value converted into the dB value to the TPC controlling portion 402.

The TPC controlling portion 402 outputs a TPC value (e) output from the converting portion 401 to the addition portion 403 (e). However, if a forced down control command (c) is output from the power threshold value/timing judging portion 406, the TPC controlling portion 402 outputs, to the addition portion 403, a TPC value (e) which gives a command to decrease the transmit power by a predetermined amount even when the TPC value output from the converting portion 401 is an up command. Incidentally, sometimes a forced down control command (c) is output from the power threshold value/timing judging portion 406 and the TPC value output from the converting portion 401 is a down command. In this case, the TPC controlling portion 402 may output, to the addition portion 403, a TPC value (e) which gives a command to decrease the transmit power forcedly by a predetermined amount or may output a TPC value (e) output from the converting portion 401 to the addition portion 403 as it is.

The addition portion 403 outputs a power increase and decrease value to the addition portion 404. Moreover, the addition portion 403 performs loopback by which the TPC value (e) output from the TPC controlling portion 402 is added to the power increase and decrease value which the addition portion 403 outputs to the addition portion 404. An initial value of the power increase and decrease value which the addition portion 403 outputs to the addition portion 404 may be set at “0”, for example.

The addition portion 404 adds an initial power value and the power increase and decrease value output from the addition portion 403. The initial power value is, for example, an initial value of the transmit power value of the terminal 110 which is used when the power to the terminal 110 is turned on. The addition portion 404 outputs the addition result to the transmit power controlling portion 309 (see FIG. 3) as the transmit power value. Moreover, the addition portion 404 outputs the transmit power value to the timing variation accumulating portion 405 and the power threshold value/timing judging portion 406.

Furthermore, in the addition portion 404, a predetermined transmit power MAX value is set. The transmit power MAX value is the maximum value of the transmit power to the base station 120 from the terminal 110. The addition portion 404 outputs a MAX value flag (f) to the power threshold value/timing judging portion 406 when the calculated transmit power value reaches the transmit power MAX value.

Moreover, in the addition portion 404, a predetermined initial power min value may be set. The initial power min value is the minimum value of the transmit power to the base station 120 from the terminal 110. The addition portion 404 may output a min value flag to the power threshold value/timing judging portion 406 when the calculated transmit power value reaches the initial power min value.

The timing variation accumulating portion 405 accumulates the TA information output from the demodulating portion 305 (see FIG. 3). For example, the timing variation accumulating portion 405 sequentially adds the TA information output from the demodulating portion 305 and stores the addition result as timing variation. This makes it possible to accumulate the variation in the transmission timing of the terminal 110. The accumulation result of the variation in timing indicates the situation regarding communication between the terminal 110 and the base station 120.

Moreover, in the timing variation accumulating portion 405, a predetermined power threshold value is set. The predetermined power threshold value may be a value obtained by subtracting a predetermined value from the transmit power MAX value. The timing variation accumulating portion 405 performs accumulation of the timing variation only in a period in which the transmit power value output from the addition portion 404 is more than or equal to the predetermined power threshold value. This makes it possible to perform transmit power control based on the timing variation in a period in which the transmit power of the terminal 110 is large.

Furthermore, the timing variation accumulating portion 405 may accumulate the sum total of the TA information and the path fluctuation information output from the path search/cell search portion 303 (see FIG. 3). This makes it possible to obtain the accumulation value which indicates the situation regarding communication between the terminal 110 and the base station 120 with a higher degree of precision. For example, the timing variation accumulating portion 405 sequentially adds the TA information output from the demodulating portion 305 and the path fluctuation information output from the path search/cell search portion 303 and holds the addition result as timing variation.

In addition, since the TA information and the path fluctuation information may take positive and negative values, the timing variation accumulating portion 405 performs additions with consideration given to whether the TA information and the path fluctuation information are positive or negative. The timing variation accumulating portion 405 outputs the accumulated timing variation to the power threshold value/timing judging portion 406 as a timing variation accumulation value (b).

In the power threshold value/timing judging portion 406, a predetermined power threshold value and a predetermined timing threshold value are set. The power threshold value set in the power threshold value/timing judging portion 406 is the same as the power threshold value set in the timing variation accumulating portion 405. The timing threshold value may be set at “14”, for example.

The power threshold value/timing judging portion 406 judges whether or not the timing variation accumulation value (b) output from the timing variation accumulating portion 405 is less than or equal to the predetermined timing threshold value in a period in which the transmit power value output from the addition portion 404 is more than or equal to the predetermined power threshold value. Then, if the timing variation accumulation value (b) is less than or equal to the predetermined timing threshold value, the power threshold value/timing judging portion 406 outputs, to the TPC controlling portion 402, a forced down control command (c) which gives a command to perform forced down control by which the transmit power is decreased by a predetermined amount.

Moreover, the power threshold value/timing judging portion 406 may be configured not to output the forced down control command (c) to the TPC controlling portion 402 in a period in which the MAX value flag (f) is not output from the addition portion 404. This makes it possible to perform forced down control only when the timing variation accumulation value (b) is less than or equal to the predetermined timing threshold value and the transmit power value of the terminal 110 has reached the transmit power MAX value.

Furthermore, after giving a command to perform the forced down control, when the received power becomes lower than the received power observed at the time of issuance of the command to perform the forced down control, the power threshold value/timing judging portion 406 stops the command to perform the forced down control based on the judgment result output from the received power threshold value judging portion 407. For example, when a current received power value Pb(n) becomes less than a received power threshold value Pa+Th_rp relative to a received power value Pa observed at the time of issuance of the command to perform the forced down control, the power threshold value/timing judging portion 406 stops the command to perform the forced down control. Th_rp is a minus value close to zero, for example, and may be set at −1 dB, for example.

In the received power threshold value judging portion 407, predetermined Th_rp is set. When the forced down control is started by the power threshold value/timing judging portion 406, the received power threshold value judging portion 407 holds the received power value from the received power measuring portion 304 (see FIG. 3) at that time point as Pa. The received power threshold value judging portion 407 then monitors the received power value from the received power measuring portion 304 as the current received power value Pb(n). Then, the received power threshold value judging portion 407 judges whether or not the received power value Pb(n) is less than the received power threshold value Pa+Th_rp relative to the received power value Pa and outputs the judgment result to the power threshold value/timing judging portion 406.

(The Hardware Configuration of the Terminal According to the Embodiment)

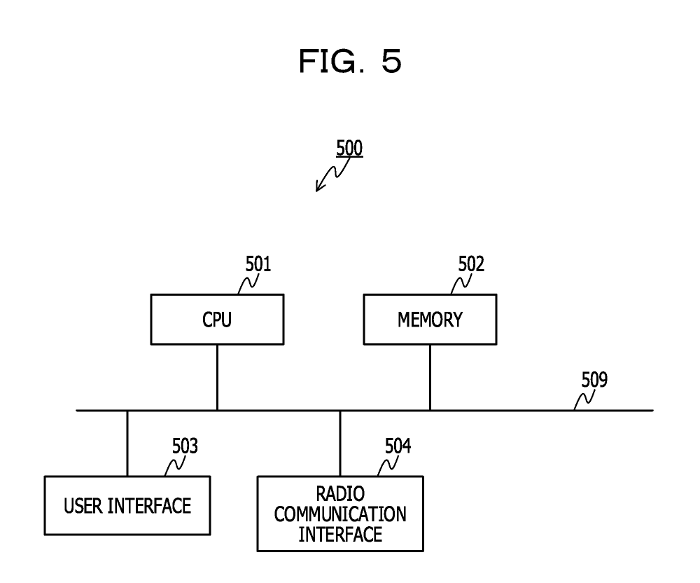

FIG. 5 is a diagram depicting an example of the hardware configuration of the terminal according to the embodiment. The terminal 110 depicted in FIG. 3 may be implemented by, for example, a communication device 500 depicted in FIG. 5. The communication device 500 includes a central processing unit (CPU) 501, memory 502, a user interface 503, and a radio communication interface 504. The CPU 501, the memory 502, the user interface 503, and the radio communication interface 504 are connected to one another by a bus 509.

The CPU 501 performs overall control of the communication device 500. The memory 502 includes, for example, main memory and auxiliary memory. The main memory is, for example, random access memory (RAM). The main memory is used as a work area of the CPU 501. The auxiliary memory is nonvolatile memory such as a magnetic disk or flash memory. In the auxiliary memory, various kinds of programs that operate the communication device 500 are stored. The program stored in the auxiliary memory is loaded into the main memory and executed by the CPU 501.

The user interface 503 includes, for example, an input device that accepts an operation input from the user and an output device that outputs information to the user. The input device may be implemented by a key (for example, a keyboard) and a remote control, for example. The output device may be implemented by a display and a speaker, for example. Moreover, the input device and the output device may be implemented by a touch panel or the like. The user interface 503 is controlled by the CPU 501.

The radio communication interface 504 is a communication interface that performs communication with the outside of the communication device 500 (for example, the base station 120) by radio. The radio communication interface 504 is controlled by the CPU 501.

The antenna 301 and the radio portion 302 depicted in FIG. 3 may be implemented by the radio communication interface 504, for example. The path search/cell search portion 303, the received power measuring portion 304, the demodulating portion 305, the encoding-decoding portion 306, the modulating portion 307, the transmit power setting portion 308, and the transmit power controlling portion 309 depicted in FIG. 3 may be implemented by the CPU 501 and the memory 502, for example.

(The Hardware Configuration of the Base Station According to the Embodiment)

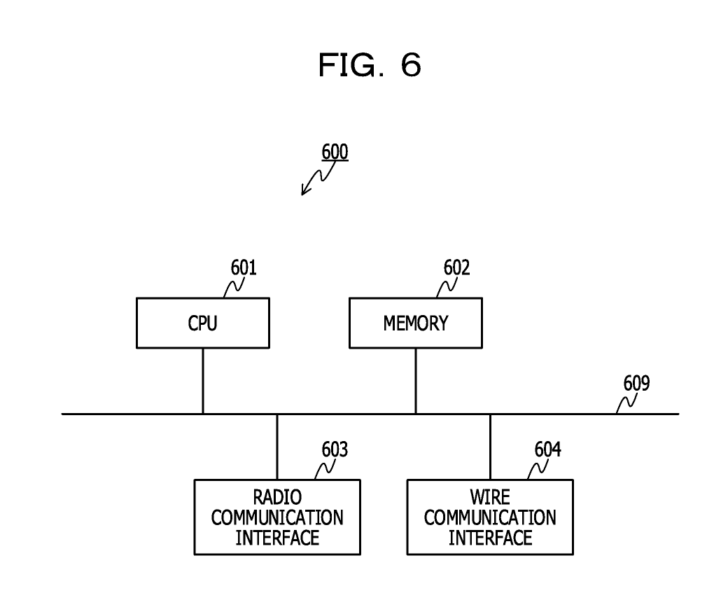

FIG. 6 is a diagram depicting an example of the hardware configuration of the base station according to the embodiment. The base station 120 depicted in FIG. 2 may be implemented by, for example, a communication device 600 depicted in FIG. 6. The communication device 600 includes a CPU 601, memory 602, a radio communication interface 603, and a wire communication interface 604. The CPU 601, the memory 602, the radio communication interface 603, and the wire communication interface 604 are connected to one another by a bus 609.

The CPU 601 performs overall control of the communication device 600. The memory 602 includes, for example, main memory and auxiliary memory. The main memory is RAM, for example. The main memory is used as a work area of the CPU 601. The auxiliary memory is nonvolatile memory such as a magnetic disk, an optical disk, or flash memory. In the auxiliary memory, various kinds of programs that operate the communication device 600 are stored. The program stored in the auxiliary memory is loaded into the main memory and executed by the CPU 601.

The radio communication interface 603 is a communication interface that performs communication with the outside of the communication device 600 (for example, the terminal 110) by radio. The radio communication interface 603 is controlled by the CPU 601.

The wire communication interface 604 is a communication interface that performs communication with the outside of the communication device 600 (for example, a core network or other base stations) through wire. The wire communication interface 604 is controlled by the CPU 601.

The reception level detecting portion 221 and the TPC inserting portion 222 of the base station 120 depicted in FIG. 2 may be implemented by the radio communication interface 603 and the CPU 601, for example.

(Processing by Transmit Power Setting Processing which is Performed by the Terminal According to the Embodiment)

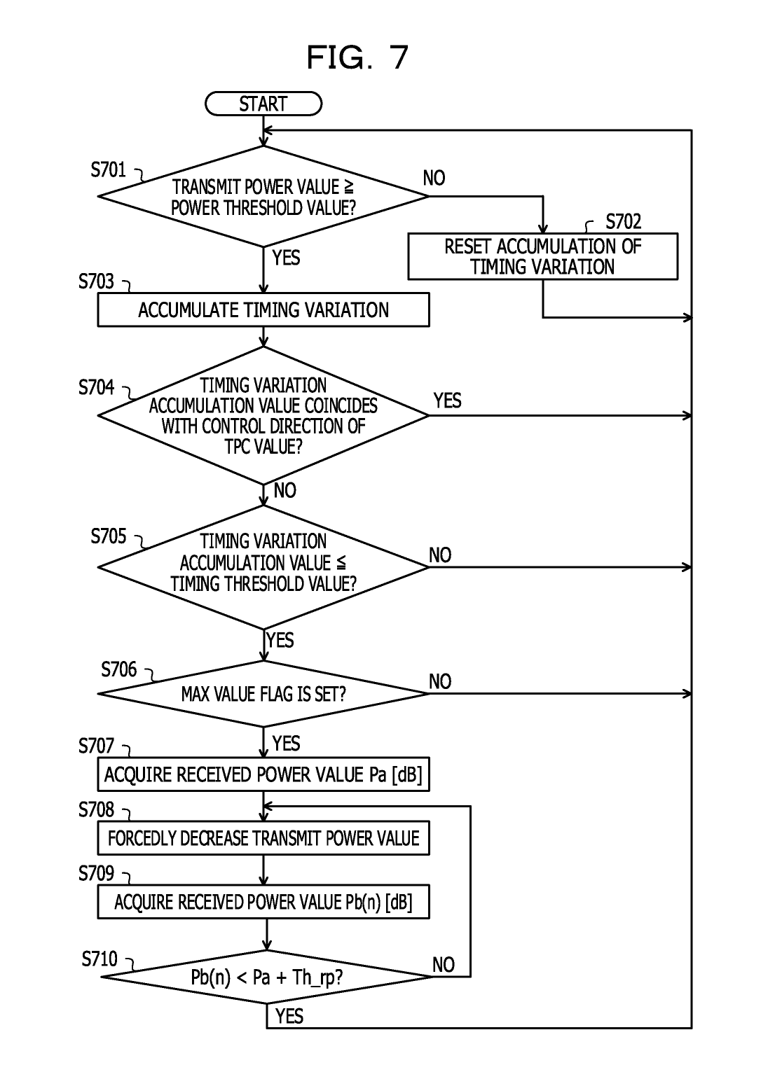

FIG. 7 is a flowchart of an example of transmit power setting processing which is performed by the terminal according to the embodiment. The terminal 110 according to the embodiment performs steps depicted in FIG. 7 by the transmit power setting portion 308, for example. First, the terminal 110 determines whether or not the current transmit power value to the base station 120 from the terminal 110 is more than or equal to the predetermined power threshold value (step S701). Step S701 is performed by the timing variation accumulating portion 405, for example.

If the transmit power value is not more than or equal to the power threshold value in step S701 (step S701: No), the terminal 110 resets the accumulation of the timing variation (step S702) and goes back to step S701. Step S702 is performed by the timing variation accumulating portion 405, for example. If the transmit power value is more than or equal to the power threshold value (step S701: Yes), the terminal 110 accumulates the timing variation indicated by the TA information and the path fluctuation information received from the base station 120 (step S703). Step S703 is performed by the timing variation accumulating portion 405, for example.

Next, the terminal 110 determines whether or not the timing variation accumulation value after accumulation in step S703 coincides with the control direction (positive or negative) of the TPC value received from the base station 120 (step S704). Step S704 is performed by the timing variation accumulating portion 405, for example. If the timing variation accumulation value after accumulation coincides with the control direction (step S704: Yes), the terminal 110 goes back to step S701.

If the timing variation accumulation value after accumulation does not coincide with the control direction in step S704 (step S704: No), the terminal 110 determines whether or not the accumulation value of the timing variation is less than or equal to the timing threshold value (step S705). Step S705 is performed by the power threshold value/timing judging portion 406, for example. If the accumulation value of the timing variation is not less than or equal to the timing threshold value (step S705: No), the terminal 110 goes back to step S701.

If the accumulation value of the timing variation is less than or equal to the timing threshold value in step S705 (step S705: Yes), the terminal 110 determines whether or not the MAX value flag is set (step S706). Step S706 is performed by the power threshold value/timing judging portion 406, for example. If the MAX value flag is not set (step S706: No), the terminal 110 goes back to step S701.

If the MAX value flag is set in step S706 (step S706: Yes), it is possible to determine that the transmit power to the base station 120 from the terminal 110 is too large. Examples of such a case include a case where the command by the TPC value from the base station 120 is not properly followed and a case where the TPC value of the down command is erroneously received by the terminal 110 as the TPC value of the up command. In this case, the terminal 110 acquires a current received power value Pa [dB] based on the received power value from the received power measuring portion 304 (step S707). Step S707 is performed by the received power threshold value judging portion 407, for example.

Next, the terminal 110 forcedly decreases the transmit power value to the base station 120 from the terminal 110 irrespective of the TPC value received from the base station 120 (step S708). Step S708 is performed by the TPC controlling portion 402, for example. Next, the terminal 110 acquires a current received power value Pb(n) [dB] based on the received power value from the received power measuring portion 304 (step S709). Step S709 is performed by the received power threshold value judging portion 407, for example.

Next, the terminal 110 determines whether or not the received power value Pb(n) acquired in step S709 is less than a received power threshold value Pa+Th_rp relative to the received power value Pa acquired in step S707 (step S710). Step S710 is performed by the received power threshold value judging portion 407, for example. Th_rp may be set at a minus value close to 0 dB, for example. This makes it possible to determine whether or not the received power decreases after the terminal 110 starts the control by which the terminal 110 forcedly decreases the transmit power.

If the received power value Pb(n) is not less than the received power threshold value Pa+Th_rp in step S710 (step S710: No), the terminal 110 goes back to step S708. If the received power value Pb(n) is less than the received power threshold value Pa+Th_rp (step S710: Yes), it is possible to determine that the current situation is a situation in which a further decrease in the transmit power value results in a reduction in communication quality due to an excessive decrease in the transmit power.

As such a situation, a situation in which, for example, a state in which the terminal 110 moves in a direction in which the terminal 110 moves closer to the base station 120 is changed to a state in which the terminal 110 moves in a direction in which the terminal 110 moves away from the base station 120 is conceivable. Alternatively, as such a situation, a situation in which, for example, the propagation environment between the terminal 110 and the base station 120 is degraded due to fading or the like is conceivable. In this case, the terminal 110 goes back to step S701.

As a result, the terminal 110 stops the control by which the terminal 110 forcedly decreases the transmit power value and resumes the control of the transmit power based on the TPC value received from the base station 120. In such a situation, the base station 120 transmits, to the terminal 110, the TPC value which gives a command to the terminal 110 to increase the transmit power. In this case, the terminal 110 increases the transmit power after receiving this TPC value.

(The Transmit Power Control which is Performed by the Terminal According to the Embodiment)

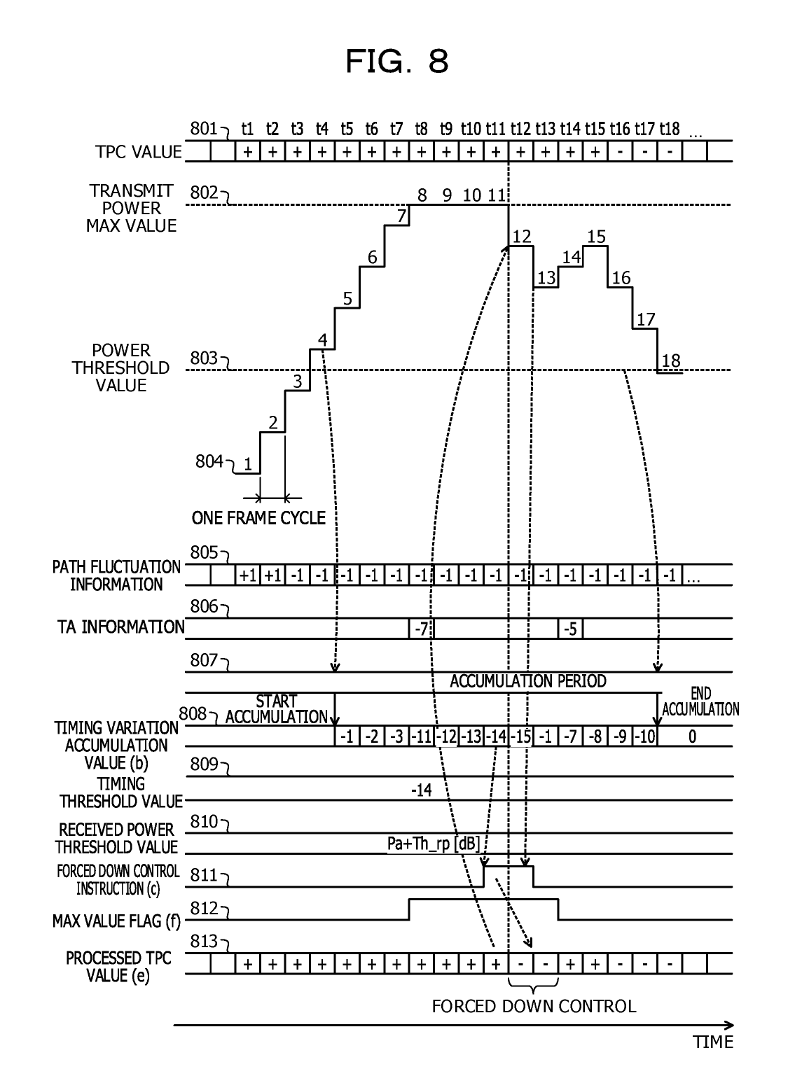

FIG. 8 is a diagram depicting an example of the transmit power control which is performed by the terminal according to the embodiment. In the transmit power controlling portion 309 depicted in FIG. 4, the transmit power control depicted in FIG. 8, for example, is performed. In FIG. 8, the horizontal axis represents time. Times t1 to t18, . . . indicate times in one frame cycle.

A TPC value 801 is a TPC value which the terminal 110 receives from the base station 120 and is input to the converting portion 401. In the TPC value 801, “+” is a TPC value (an up command) which gives a command to increase the transmit power value and “−” is a TPC value (a down command) which gives a command to decrease the transmit power value. In the example depicted in FIG. 8, the TPC value 801 is “+” at times t1 to t15 and “−” at times t16 to t18.

A transmit power MAX value 802 is a transmit power MAX value which is set in the addition portion 404. A power threshold value 803 is a power threshold value (a minus power threshold value) which is set in the timing variation accumulating portion 405 and the received power threshold value judging portion 407.

A transmit power value 804 is a transmit power value indicating the transmit power of the terminal 110, the transmit power value which is output from the addition portion 404. In FIG. 8, numerical values “1” to “18” written along the transmit power value 804 indicate times t1 to t18 (1st to 18th frames), respectively.

Path fluctuation information 805 is path fluctuation information indicating the measurement result of downlink path fluctuations, the measurement result which is input to the timing variation accumulating portion 405. TA information 806 is TA information which the terminal 110 receives from the base station 120 and is input to the timing variation accumulating portion 405.

An accumulation period 807 is a period in which the timing variation accumulating portion 405 accumulates the timing variation and outputs a timing variation accumulation value (b) to the power threshold value/timing judging portion 406.

A timing variation accumulation value 808 is a timing variation accumulation value (b) which is output from the timing variation accumulating portion 405. For example, in a state in which the terminal 110 moves in a direction in which the terminal 110 moves away from the base station 120, the timing variation accumulation value 808 is a positive value. On the other hand, in a state in which the terminal 110 moves in a direction in which the terminal 110 moves closer to the base station 120, the timing variation accumulation value 808 is a negative value.

A timing threshold value 809 is a timing threshold value which is set in the power threshold value/timing judging portion 406. A received power threshold value 810 is a received power threshold value which is set in the received power threshold value judging portion 407. A forced down control command 811 is a forced down control command (c) which is output to the TPC controlling portion 402 from the power threshold value/timing judging portion 406.

A MAX value flag 812 is a MAX value flag (f) which is output to the power threshold value/timing judging portion 406 from the addition portion 404. A processed TPC value 813 is a TPC value (e) which is output to the addition portion 403 from the TPC controlling portion 402.

In the example depicted in FIG. 8, from time t1, the transmit power value 804 increases by 1 unit in accordance with the TPC value 801, and, at time t4 (in the 4th subframe), the transmit power value 804 exceeds the power threshold value 803. Moreover, at time t8, the transmit power value 804 reaches the transmit power MAX value 802. Therefore, at times t8 to t11, although the TPC value 801 is “+”, the transmit power value 804 remains at the transmit power MAX value 802. Moreover, the MAX value flag 812 is output to the power threshold value/timing judging portion 406 from the addition portion 404.

Since the transmit power value 804 exceeds the power threshold value 803 at time t4, as indicated in the accumulation period 807, the timing variation accumulating portion 405 starts accumulation of timing variation from time t5 immediately after time t4. In the example depicted in FIG. 8, at times t5 to t7, the path fluctuation information 805 is “−1” and the TA information 806 is not received. Therefore, at times t5 to t7, the timing variation accumulation values 808 are “4”, “−2”, and “−3”, respectively.

At time t8, since the path fluctuation information 805 is “−1” and “−7” is received as the TA information 806, the timing variation accumulation value 808 is “−11”. At times t9 to t12, the path fluctuation information 805 is “−1” and the TA information 806 is not received. Therefore, at times t9 to t12, the timing variation accumulation values 808 are “−12”, “−13”, “−14”, and “−15”, respectively.

At time t11, the timing variation accumulation value 808 becomes less than or equal to “−14” which is the timing threshold value 809 and the timing variation accumulation value 808 (−14) and the TPC value 801 (+) do not coincide in direction. Therefore, the forced down control command 811 is output to the TPC controlling portion 402 from the power threshold value/timing judging portion 406. As a result, at times t12 and t13, the processed TPC value 813 becomes “−” by the forced down control irrespective of the TPC value 801. Thus, at times t12 and t13, the transmit power value 804 decreases.

Here, assume that the received power Pb(n) at time t12 becomes less than the received power threshold value 810 (Pa+Th_rp). In this case, from time t13, the output of the forced down control command 811 to the TPC controlling portion 402 from the power threshold value/timing judging portion 406 is stopped. Therefore, at times t14 to t18, as is the case with the TPC value 801, the processed TPC values 813 become “+”, “+”, “−”, “−”, and “−”, respectively. Moreover, at this time, the MAX value flag 812 is reset. Furthermore, the timing variation accumulation value 808 is reset and the accumulation of the timing variation is ended.

As depicted in FIG. 8, when the transmit power value 804 exceeds the power threshold value 803 and the timing variation accumulation value 808 becomes less than or equal to the threshold value, the transmit power controlling portion 309 starts forced down control of the transmit power value 804. Then, when the received power becomes less than the received power threshold value 810 after the start of the forced down control, the transmit power controlling portion 309 stops the forced down control.

(Control by which the Transmit Power is Forcedly Increased)

The control by which the terminal 110 forcedly decreases the transmit power in accordance with fluctuations in transmission timing has been described above, but control by which the terminal 110 forcedly increases the transmit power in accordance with fluctuations in transmission timing may be performed.

For example, when a forced up control command is output, even when the TPC value from the converting portion 401 is a down command, the TPC controlling portion 402 depicted in FIG. 4 outputs, to the addition portion 403, a TPC value (e) which gives a command to increase the transmit power by a predetermined amount. Incidentally, sometimes a forced up control command is output from the power threshold value/timing judging portion 406 and the TPC value output from the converting portion 401 is an up command. In this case, the TPC controlling portion 402 may output, to the addition portion 403, a TPC value (e) which gives a command to increase the transmit power forcedly by a predetermined amount or may output a TPC value (e) output from the converting portion 401 to the addition portion 403 as it is.

The timing variation accumulating portion 405 depicted in FIG. 4 performs accumulation of the TA information and the path fluctuation information only in a period in which the transmit power value output from the addition portion 404 is less than or equal to the predetermined power threshold value. The timing variation accumulating portion 405 outputs the accumulated transmission timing variation to the power threshold value/timing judging portion 406 as a timing variation accumulation value (b).

The power threshold value/timing judging portion 406 depicted in FIG. 4 judges whether or not the timing variation accumulation value (b) output from the timing variation accumulating portion 405 is more than or equal to the predetermined timing threshold value in a period in which the transmit power value output from the addition portion 404 is less than or equal to the predetermined power threshold value. Then, when the timing variation accumulation value (b) is more than or equal to the predetermined timing threshold value, the power threshold value/timing judging portion 406 outputs, to the TPC controlling portion 402, a forced up control command which gives a command to perform forced up control by which the transmit power is increased by a predetermined amount.

Moreover, the power threshold value/timing judging portion 406 may be configured not to output the forced up control command to the TPC controlling portion 402 in a period in which the min value flag is not output from the addition portion 404. This makes it possible to perform the forced up control only when the timing variation accumulation value is more than or equal to the predetermined timing threshold value and the transmit power value of the terminal 110 has reached the initial power min value.

Furthermore, after giving a command to perform the forced up control, when the received power becomes higher than the received power observed at the time of issuance of the command to perform the forced up control, the power threshold value/timing judging portion 406 stops the command to perform the forced up control based on the judgment result output from the received power threshold value judging portion 407. For example, when a current received power value Pb(n) becomes more than a received power threshold value Pa+Th_rp relative to a received power value Pa observed at the time of issuance of the command to perform the forced up control, the power threshold value/timing judging portion 406 stops the command to perform the forced up control. Th_rp is a plus value close to zero, for example, and may be set at 1 dB, for example.

When the forced up control is started by the power threshold value/timing judging portion 406, the received power threshold value judging portion 407 depicted in FIG. 4 holds the received power value from the received power measuring portion 304 at that time point as Pa. The received power threshold value judging portion 407 then monitors the received power value from the received power measuring portion 304 as the current received power value Pb(n). Then, the received power threshold value judging portion 407 judges whether or not the received power value Pb(n) is more than the received power threshold value Pa+Th_rp relative to the received power value Pa and outputs the judgment result to the power threshold value/timing judging portion 406.

(Processing by Transmit Power Setting Processing which is Performed by the Terminal According to the Embodiment)

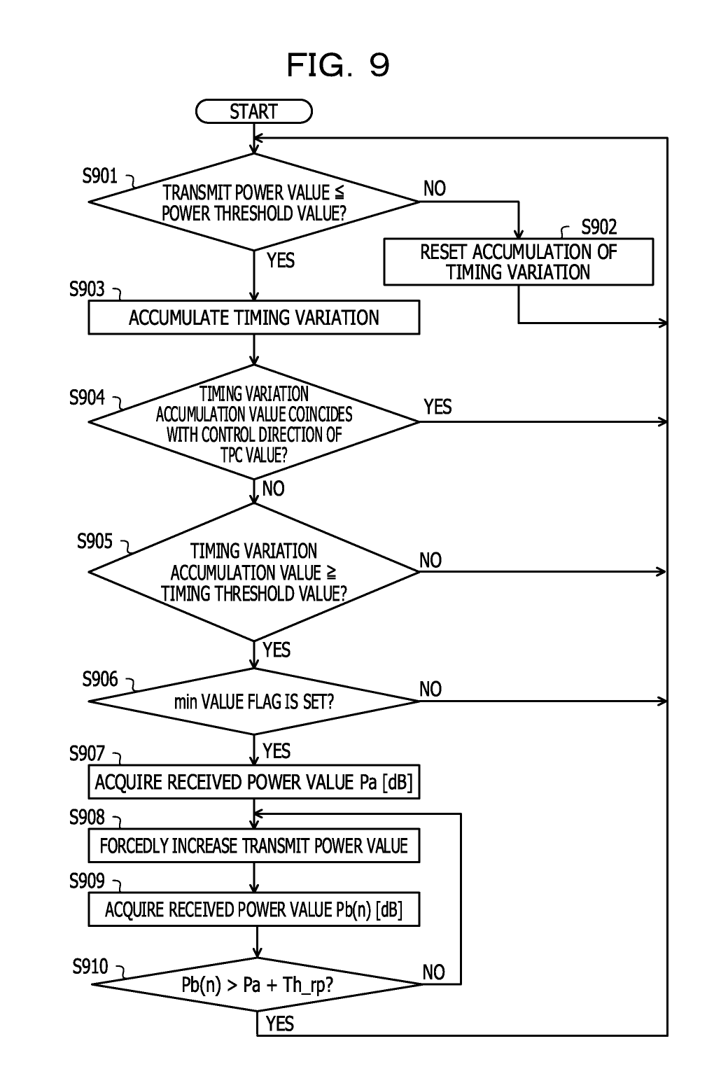

FIG. 9 is a flowchart of another example of the transmit power setting processing which is performed by the terminal according to the embodiment. When the terminal 110 according to the embodiment forcedly increases the transmit power in accordance with fluctuations in transmission timing, the terminal 110 performs steps depicted in FIG. 9 by the transmit power setting portion 308, for example. First, the terminal 110 determines whether or not the current transmit power value to the base station 120 from the terminal 110 is less than or equal to the predetermined power threshold value (step S901). Step S901 is performed by the timing variation accumulating portion 405, for example.

If the transmit power value is not less than or equal to the power threshold value in step S901 (step S901: No), the terminal 110 resets the accumulation of the timing variation (step S902) and goes back to step S901. Step S902 is performed by the timing variation accumulating portion 405, for example. If the transmit power value is less than or equal to the power threshold value (step S901: Yes), the terminal 110 accumulates the timing variation indicated by the TA information and the path fluctuation information received from the base station 120 (step S903). Step S903 is performed by the timing variation accumulating portion 405, for example.

Next, the terminal 110 determines whether or not the timing variation accumulation value after accumulation performed in step S903 coincides with the control direction (positive or negative) of the TPC value received from the base station 120 (step S904). Step S904 is performed by the timing variation accumulating portion 405, for example. If the timing variation accumulation value after accumulation coincides with the control direction (step S904: Yes), the terminal 110 goes back to step S901.

If the timing variation accumulation value after accumulation does not coincide with the control direction in step S904 (step S904: No), the terminal 110 determines whether or not the accumulation value of the timing variation is more than or equal to the timing threshold value (step S905). Step S905 is performed by the power threshold value/timing judging portion 406, for example. If the accumulation value of the timing variation is not more than or equal to the timing threshold value (step S905: No), the terminal 110 goes back to step S901.

If the accumulation value of the timing variation is more than or equal to the timing threshold value in step S905 (step S905: Yes), the terminal 110 determines whether or not the min value flag is set (step S906). Step S906 is performed by the power threshold value/timing judging portion 406, for example. The min value flag is, for example, a flag which is set when the transmit power to the base station 120 from the terminal 110 reaches a predetermined minimum value and is cleared when the control by which the transmit power of the terminal 110 is forcedly increased is stopped.

If the min value flag is not set in step S906 (step S906: No), the terminal 110 goes back to step S901. If the min value flag is set (step S906: Yes), it is possible to determine that the transmit power to the base station 120 from the terminal 110 is too small. Examples of such a case include a case where the command by the TPC value from the base station 120 is not properly followed and a case where the TPC value of the up command is erroneously received by the terminal 110 as the TPC value of the down command. In this case, the terminal 110 acquires a current received power value Pa [dB] based on the received power value from the received power measuring portion 304 (step S907). Step S907 is performed by the received power threshold value judging portion 407, for example.

Next, the terminal 110 forcedly increases the transmit power value to the base station 120 from the terminal 110 irrespective of the TPC value received from the base station 120 (step S908). Step S908 is performed by the TPC controlling portion 402, for example. Then, the terminal 110 acquires a current received power value Pb(n) [dB] based on the received power value from the received power measuring portion 304 (step S909). Step S909 is performed by the received power threshold value judging portion 407, for example.

Next, the terminal 110 determines whether or not the received power value Pb(n) acquired in step S909 is more than a received power threshold value Pa+Th_rp relative to the received power value Pa acquired in step S907 (step S910). Step S910 is performed by the received power threshold value judging portion 407, for example. Th_rp may be set at a plus value close to 0 dB, for example. This makes it possible to determine whether or not the received power increases after the start of the control by which the terminal 110 forcedly increases the transmit power.

If the received power value Pb(n) is not more than the received power threshold value Pa+Th_rp in step S910 (step S910: No), the terminal 110 goes back to step S908. If the received power value Pb(n) is more than the received power threshold value Pa+Th_rp (step S910: Yes), it is possible to determine that the current situation is a situation in which a further increase in the transmit power value results in an excessive increase in the transmit power. An excessive increase in the transmit power causes, for example, an increase in the power consumption of the terminal 110 or interference with other terminals in the base station 120.

As such a situation, a situation in which, for example, a state in which the terminal 110 moves in a direction in which the terminal 110 moves away from the base station 120 is changed to a state in which the terminal 110 moves in a direction in which the terminal 110 moves closer to the base station 120 is conceivable. Alternatively, as such a situation, a situation in which, for example, degradation in the propagation environment between the terminal 110 and the base station 120 caused by fading or the like has been resolved is conceivable. In this case, the terminal 110 goes back to step S901.

As a result, the terminal 110 stops the control by which the terminal 110 forcedly increases the transmit power value and resumes the control of the transmit power based on the TPC value received from the base station 120. In such a situation, the base station 120 transmits, to the terminal 110, the TPC value which gives a command to the terminal 110 to decrease the transmit power. In this case, the terminal 110 decreases the transmit power after receiving this TPC value.

As described above, with the terminal 110 according to the embodiment, in a configuration in which the control by which the transmit power is forcedly decreased in accordance with fluctuations in transmission timing is performed, it is possible to stop this control in accordance with the received power from the base station 120. This makes it possible to curb an excessive decrease in the transmit power. As a result, for example, it is possible to curb a reduction in quality of communication to the base station 120 from the terminal 110 due to an excessive decrease in the transmit power.

Alternatively, with the terminal 110 according to the embodiment, in a configuration in which the control by which the transmit power is forcedly increased in accordance with fluctuations in transmission timing is performed, it is possible to stop this control in accordance with the received power from the base station 120. This makes it possible to curb an excessive increase in the transmit power. As a result, for example, it is possible to curb an increase in the power consumption in the terminal 110 and interference with other terminals in the base station 120.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A wireless communication device comprising:
a memory; and
a processor coupled to the memory and configured to:
receive a first control signal and a second control signal from another wireless communication device, the first control signal being a control signal for adjusting a transmission timing of the wireless communication device, the second control signal being a control signal for adjusting a transmission power of the wireless communication device,
perform a first adjustment for the transmission power of the wireless communication device based on the second control signal,
start a second adjustment for the transmission power of the wireless communication device based on the first control signal, and
stop the second adjustment based on a received power from the another wireless communication device.

2. The wireless communication device according to claim 1, wherein
the second adjustment decreases the transmission power of the wireless communication device.

3. The wireless communication device according to claim 2, wherein
the second adjustment decreases the transmission power of the wireless communication device even though the second control signal commands the wireless communication device to increase the transmission power of the wireless communication device.

4. The wireless communication device according to claim 2, wherein
the second adjustment decreases the transmission power of the wireless communication device by a predetermined amount in a predetermined cycle even though the second control signal commands the wireless communication device to increase the transmission power of the wireless communication device.

5. The wireless communication device according to claim 2, wherein
the second adjustment is started when the transmission power of the wireless communication is equal to or more than a predetermined power.

6. The wireless communication device according to claim 2, wherein
the second adjustment is stopped when an amount of decrease of the received power, after starting the second adjustment, becomes greater than a predetermined amount.

7. The wireless communication device according to claim 1, wherein
the second adjustment increases the transmission power of the wireless communication device.

8. The wireless communication device according to claim 7, wherein
the second adjustment increases the transmission power of the wireless communication device even though the second control signal commands the wireless communication device to decrease the transmission power of the wireless communication device.

9. The wireless communication device according to claim 7, wherein
the second adjustment increases the transmission power of the wireless communication device by a predetermined amount in a predetermined cycle even though the second control signal commands the wireless communication device to decrease the transmission power of the wireless communication device.

10. The wireless communication device according to claim 7, wherein
the second adjustment is started when the transmission power of the wireless communication is equal to or less than a predetermined power.

11. The wireless communication device according to claim 7, wherein
the second adjustment is stopped when an amount of increase of the received power, after starting the second adjustment, becomes greater than a predetermined amount.

12. A wireless communication method comprising:
receiving a first control signal and a second control signal from another wireless communication device, the first control signal being a control signal for adjusting a transmission timing of the wireless communication device, the second control signal being a control signal for adjusting a transmission power of the wireless communication device;
performing a first adjustment for the transmission power of the wireless communication device based on the second control signal;
starting a second adjustment for the transmission power of the wireless communication device based on the first control signal; and
stopping the second adjustment based on a received power from the another wireless communication device.
